(19) United States
(12) Patent Application Publication
(10) Pub. No.: US 2024/0422523 A1
(43) Pub. Date: Dec. 19, 2024

(54) SATELLITE-BASED WIRELESS COMMUNICATION (SBWC) SATELLITE VISIBILITY DETERMINATION BASED ON GLOBAL NAVIGATION SATELLITE SYSTEM (GNSS) SATELLITE VISIBILITY

(71) Applicant: QUALCOMM Incorporated, San Diego, CA (US)

(72) Inventors: Francesco GRILLI, La Jolla, CA (US); Carl HARDIN, Encinitas, CA (US)

(21) Appl. No.: 18/732,932

(22) Filed: Jun. 4, 2024

Related U.S. Application Data
(60) Provisional application No. 63/508,723, filed on Jun. 16, 2023.

(51) Int. Cl. H04W 8/00; H04W 24/08; H04W 64/00; H04W 84/06

(52) U.S. Cl. CPC H04W 8/005; H04W 24/08; H04W 64/006; H04W 84/06

(57) ABSTRACT

Techniques are disclosed for satellite-based wireless communication (SBWC) satellite visibility determination based on global navigation satellite system (GNSS) satellite visibility. The techniques can include identifying one or more visible GNSS satellites based on one or more received GNSS signals, estimating an orientation of a directional radio-frequency (RF) antenna based on respective expected positions of the one or more visible GNSS satellites, determining whether any of a plurality of SBWC satellites are visible based on the estimated orientation of the directional RF antenna, and initiating an SBWC communication procedure responsive to a determination that at least one SBWC satellite among the plurality of SBWC satellites is visible.

### CROSS-REFERENCE TO RELATED APPLICATIONS

This application claims the benefit of U.S. Provisional Application No. 63/508,723, filed Jun. 16, 2023, entitled “SATELLITE-BASED WIRELESS COMMUNICATION (SBWC) SATELLITE VISIBILITY DETERMINATION BASED ON GLOBAL NAVIGATION SATELLITE SYSTEM (GNSS) SATELLITE VISIBILITY” which is incorporated herein by reference in its entirety.

### BACKGROUND

### 1. Field of Disclosure

The present disclosure relates generally to the field of wireless communications, and more specifically to wireless communication and device positioning using radio frequency (RF) signals.

### 2. Description of Related Art

In order to facilitate communication with Earth-orbiting satellites, terrestrial wireless communication devices can be equipped with directional radio frequency (RF) antennas. A directional RF antenna can, with respect to wireless communications with devices positioned within a field-of-view (FOV) defined by an orientation and beamwidth of the directional RF antenna, provide improved levels of radiated energy (of RF transmission) and/or received energy (of RF reception) relative to an omni-directional RF antenna. This improved performance with respect to wireless communications with devices positioned within the FOV of a directional RF antenna can come at a cost of reduced performance with respect to wireless communications with devices residing outside of the FOV of the directional RF antenna. To facilitate wireless communication with a remote device at a known position, a directional RF antenna can be oriented such that the known position is within the FOV of the directional RF antenna.

### BRIEF SUMMARY

An example method for wireless communication by a wireless communication device, according to this disclosure, may include identifying one or more visible global navigation satellite system (GNSS) satellites based on one or more received GNSS signals, estimating an orientation of a directional radio-frequency (RF) antenna based on respective expected positions of the one or more visible GNSS satellites, determining whether any of a plurality of satellite-based wireless communication (SBWC) satellites are visible based on the estimated orientation of the directional RF antenna, and initiating an SBWC communication procedure responsive to a determination that at least one SBWC satellite among the plurality of SBWC satellites is visible.

An example wireless communication device, according to this disclosure, may include at least one directional RF antenna, an SBWC radio communicatively coupled with the at least one directional RF antenna, a GNSS receiver configured to receive one or more GNSS signals, a memory, and one or more processors communicatively coupled with the SBWC radio, the GNSS receiver, and the memory, wherein the one or more processors are configured to identify one or more visible GNSS satellites based on the one or more received GNSS signals, estimate an orientation of the at least one directional RF antenna based on respective expected positions of the one or more visible GNSS satellites, determine whether any of a plurality of SBWC satellites are visible based on the estimated orientation of the at least one directional RF antenna, and initiate an SBWC communication procedure responsive to a determination that at least one SBWC satellite among the plurality of SBWC satellites is visible.

An example wireless communication apparatus, according to this disclosure, may include means for identifying one or more visible GNSS satellites based on one or more received GNSS signals, means for estimating an orientation of a directional RF antenna based on respective expected positions of the one or more visible GNSS satellites, means for determining whether any of a plurality of SBWC satellites are visible based on the estimated orientation of the directional RF antenna, and means for initiating an SBWC communication procedure responsive to a determination that at least one SBWC satellite among the plurality of SBWC satellites is visible.

An example non-transitory computer-readable medium, according to this disclosure, may store instructions for wireless communication by a wireless communication device, the instructions including code to identify one or more visible GNSS satellites based on one or more received GNSS signals, estimate an orientation of a directional RF antenna based on respective expected positions of the one or more visible GNSS satellites, determine whether any of a plurality of SBWC satellites are visible based on the estimated orientation of the directional RF antenna, and initiate an SBWC communication procedure responsive to a determination that at least one SBWC satellite among the plurality of SBWC satellites is visible.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a simplified diagram of a GNSS system, according to an embodiment.

FIG. 3A is a block diagram illustrating a first example operating environment, according to aspects of the disclosure.

FIG. 3B is a block diagram illustrating a second example operating environment, according to aspects of the disclosure.

FIG. 4 is a block diagram illustrating a third example operating environment, according to aspects of the disclosure.

FIG. 5 is a block diagram showing an example satellite visibility determination method, according to aspects of the disclosure.

FIG. 6 is a block diagram of an embodiment of a mobile device, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

Various aspects generally relate to wireless communications, and more particularly to satellite based device positioning and wireless communication. Some aspects more specifically relate to satellite-based wireless communication (SBWC) visibility determination based on visibility of global navigation satellite system (GNSS) satellites. According to some aspects, based on GNSS signals received at a wireless communication device, a determination can be made of whether any SBWC satellites are visible to the wireless communication device. According to aspects of the disclosure, the wireless communication device can identify one or more visible GNSS satellites based on the received GNSS signals.

In some examples, based on prior knowledge or expectation with respect to its own position and the positions of the visible GNSS satellites, the wireless communication device can determine an orientation of a directional radio frequency (RF) antenna used to receive the received GNSS signals. In some examples, this can be a same directional RF antenna as is to be used for SBWC communications. In other examples, the GNSS signals can be received using a different directional RF antenna than is to be used for SBWC communications. According to aspects of the disclosure, the wireless communication device can determine whether any SBWC satellites are visible based on the orientation of whichever directional RF antenna is to be used for SBWC communications. In some examples, the wireless communication device can monitor a wireless frequency band for SBWC signals if it determines that one or more SBWC satellites are visible, but can refrain from monitoring the wireless frequency band for SBWC signals if it determines that no SBWC satellites are visible. According to aspects of the disclosure, by adaptively monitoring (or not monitoring) the wireless frequency band based on the presence (or absence) of visible SBWC satellites, the wireless communication device can conserve power that may otherwise be wasted in conjunction with monitoring the wireless frequency band during times when there are not likely to be any receivable SBWC signals.

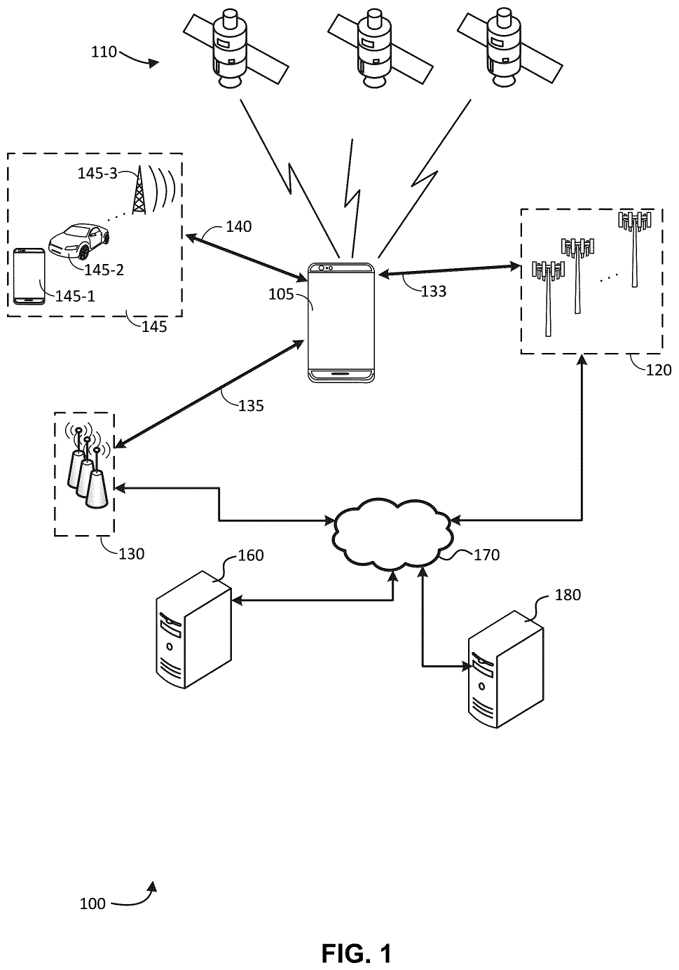

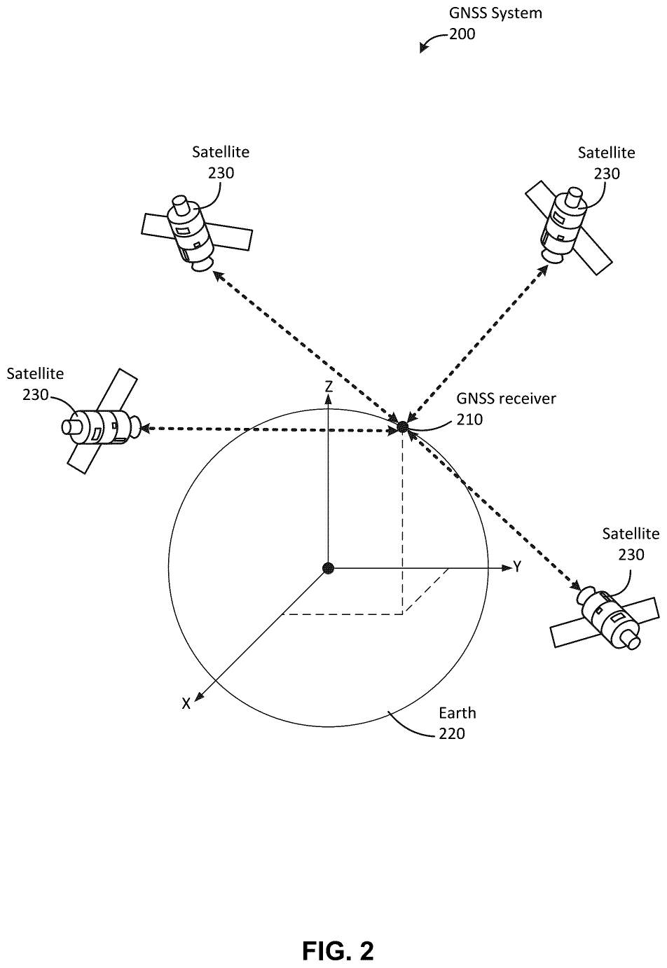

FIG. 1 is a simplified illustration of a positioning system 100 in which a mobile device 105 may use the techniques provided herein for determining communication satellite visibility based on GNSS satellite visibility, according to various embodiments. The techniques described herein may be implemented by one or more components of the positioning system 100. The positioning system 100 can include: a mobile device 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and/or Non-Terrestrial Network (NTN) satellites; base stations 120; access points (APs) 130; location server 160; network 170; and external client 180. Generally put, the positioning system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one mobile device 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally or alternatively, because APs 130 also may be communicatively coupled with the network 170, mobile device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (cMBB), or others) that may provide access for different types of devices. In some cases, the term “cell” may refer to a portion of a geographic coverage area (e.g., a sector) over which the logical entity operates.

Satellites 110 may be utilized for positioning of the mobile device 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites.

The location server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., GNSS satellites 110, APs 130, base stations 120). The estimated location of the mobile device 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the mobile device 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular mobile device 105, the mobile device 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., mobile device 105) may be facilitated using measurements from one or more anchor devices (e.g., mobile devices 145).

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

FIG. 2 is a simplified diagram of a GNSS system 200, provided to illustrate how GNSS is generally used to determine an accurate location of a GNSS receiver 210 on earth 220. Put generally, the GNSS system 200 enables an accurate GNSS position fix of the GNSS receiver 210, which receives RF signals from GNSS satellites 230 from one or more GNSS constellations. The types of GNSS receiver 210 used may vary, depending on application. In some embodiments, for instance, the GNSS receiver 210 may comprise a standalone device or component incorporated into another device (e.g., mobile device 105 of FIG. 1). In some embodiments, the GNSS receiver 210 may be integrated into industrial or commercial equipment, such as survey equipment, Internet of Things (IoT) devices, etc.

It will be understood that the diagram provided in FIG. 2 is greatly simplified. In practice, there may be dozens of satellites 230 and a given GNSS constellation, and there are many different types of GNSS systems. As noted, GNSS systems include GPS, Galileo, GLONASS, or BDS. Additional GNSS systems include, for example, Quasi-Zenith Satellite System (QZSS) over Japan, Indian Regional Navigational Satellite System (IRNSS) over India, etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on trilateration/multilateration, which is a method of determining position by measuring distances to points at known coordinates. In general, the determination of the position of a GNSS receiver 210 in three dimensions may rely on a determination of the distance between the GNSS receiver 210 and four or more satellites 230. As illustrated, 3D coordinates may be based on a coordinate system (e.g., XYZ coordinates; latitude, longitude, and altitude; etc.) centered at the earth's center of mass. A distance between each satellite 230 and the GNSS receiver 210 may be determined using precise measurements made by the GNSS receiver 210 of a difference in time from when a RF signal is transmitted from the respective satellite 230 to when it is received at the GNSS receiver 210. To help ensure accuracy, not only does the GNSS receiver 210 need to make an accurate determination of when the respective signal from each satellite 230 is received, but many additional factors need to be considered and accounted for. These factors include, for example, clock differences at the GNSS receiver 210 and satellite 230 (e.g., clock bias), a precise location of each satellite 230 at the time of transmission (e.g., as determined by the broadcast ephemeris), the impact of atmospheric distortion (e.g., ionospheric and tropospheric delays), and the like.

To perform a traditional GNSS position fix, the GNSS receiver 210 can use code-based positioning to determine its distance to each satellite 230 based on a determined delay in a generated pseudorandom binary sequence received in the RF signals received from each satellite, in consideration of the additional factors and error sources previously noted. With the distance and location information of the satellites 230, the GNSS receiver 210 can then determine a position fix for its location. This position fix may be determined, for example, by a Standalone Positioning Engine (SPE) executed by one or more processors of the GNSS receiver 210. However, code-based positioning is relatively inaccurate and, without error correction, and is subject to many of the previously described errors. Even so, code-based GNSS positioning can provide an positioning accuracy for the GNSS receiver 210 on the order of meters.

More accurate carrier-based ranging is based on a carrier wave of the RF signals received from each satellite, and may use measurements at a base or reference station (not shown) to perform error correction to help reduce errors from the previously noted error sources. More specifically, errors (e.g., atmospheric errors sources) in the carrier-based ranging of satellites 230 observed by the GNSS receiver 210 can be mitigated or canceled based on similar carrier-based ranging of the satellites 230 using a highly accurate GNSS receiver at the base station at a known location. These measurements and the base station's location can be provided to the GNSS receiver 210 for error correction. This position fix may be determined, for example, by a Precise Positioning Engine (PPE) executed by one or more processors of the GNSS receiver 210. More specifically, in addition to the information provided to an SPE, the PPE may use base station GNSS measurement information, and additional correction information, such as troposphere and ionosphere, to provide a high accuracy, carrier-based position fix. Several GNSS techniques can be adopted in PPE, such as Differential GNSS (DGNSS), Real Time Kinematic (RTK), and Precise Point Positioning (PPP), and may provide a sub-meter accuracy (e.g., on the order of centimeters). (An SPE and/or PPE may be referred to herein as a GNSS positioning engine, and may be incorporated into a broader positioning engine that uses other (non-GNSS) positioning sources.)

Multi-frequency GNSS receiver is use satellite signals from different GNSS frequency bands (also referred to herein simply as “GNSS bands”) to determine desired information such as pseudoranges, position estimates, and/or time. Using multi-frequency GNSS may provide better performance (e.g., position estimate speed and/or accuracy) than single-frequency GNSS in many conditions. However, as discussed in more detail hereafter, using multi-frequency GNSS typically uses more power than single-frequency GNSS, e.g., processing power and battery power (e.g., to power a processor (e.g., for determining measurements), baseband processing, and/or RF processing).

Referring again to FIG. 2, the satellites 230 may be members of a single satellite constellation, i.e., a group of satellites that are part of a GNSS system, e.g., controlled by a common entity such as a government, and orbiting in complementary orbits to facilitate determining positions of entities around the world. One or more of the satellites 230 may transmit multiple satellite signals in different GNSS frequency bands, such as L1, L2, and/or L5 frequency bands. The terms L1 band, L2 band, and L5 band are used herein because these terms are used for GPS to refer to respective ranges of frequencies. Various receiver configurations may be used to receive satellite signals. For example, a receiver may use separate receive chains for different frequency bands. As another example, a receiver may use a common receive chain for multiple frequency bands that are close in frequency, for example L2 and L5 bands. As another example, a receiver may use separate receive chains for different signals in the same band, for example GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites, the X-band, used by the military and for RADAR applications, and the Ku-band (primarily downlink communication and the Ka-band (primarily uplink communications), the Ku and Ka bands used for communications satellites. The L-band is defined by IEEE as the frequency range from 1 to 2 GHZ. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

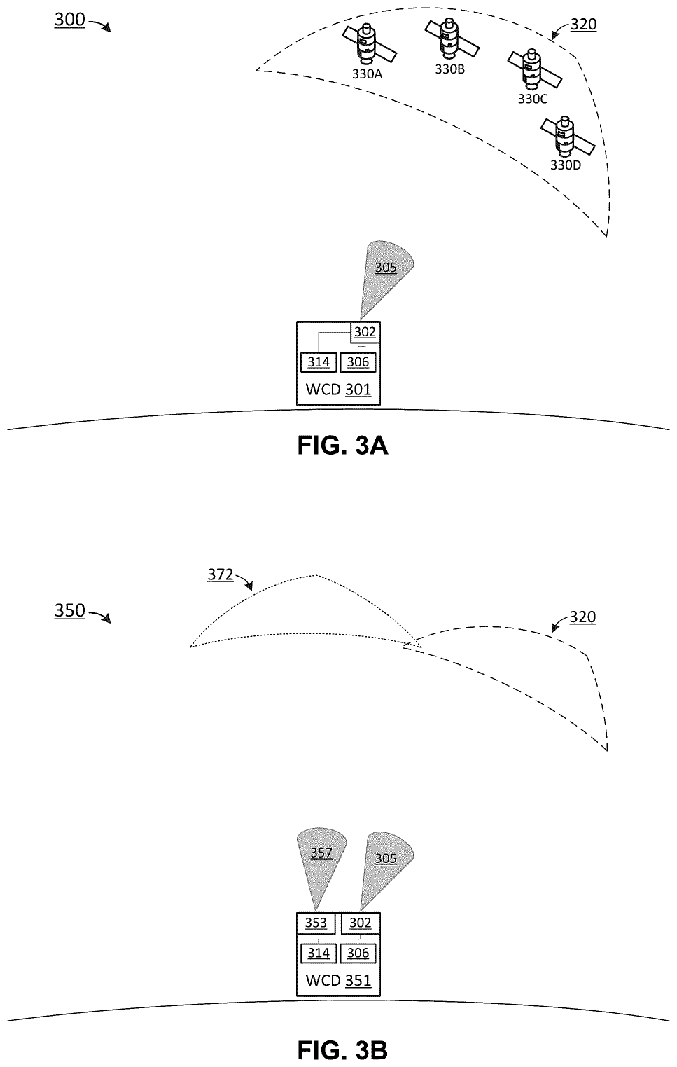

FIG. 3A is a block diagram illustrating an example operating environment 300, according to aspects of the disclosure. In operating environment 300, a wireless communication device (WCD) 301 includes a directional RF antenna 302, a GNSS receiver 306, and a satellite-based wireless communication (SBWC) radio 314, which is shared by the GNSS receiver 306 and the SBWC radio 314. GNSS satellites 330A, 330B, 330C, and 330D within a field-of-view (FOV) 320 are visible to the GNSS receiver 306 via use of the directional RF antenna 302. The size of the FOV 320 and its position in the sky can depend on the orientation and beamwidth of the directional RF antenna 302, such as may be largely defined by the orientation and beamwidth of a main lobe 305 of the directional RF antenna 302.

It is worthy of note that in the context of this disclosure, the term “visible” is not intended to refer to visibility in an optical/visual sense (such as visibility to the human eye). Rather, the term “visible,” as employed herein to describe a given satellite with respect to a given terrestrial wireless communication device (such as wireless communication device 301), means that the terrestrial wireless communication device can receive signals transmitted by that satellite with levels of received signal strength sufficient to enable the terrestrial wireless communication device to successfully detect and process those signals.

In operating environment 300, if wireless communication device 301 has prior knowledge of the positions (for example, the geocentric coordinates) of Earth-orbiting GNSS satellites, it may be able to infer the orientation of directional RF antenna 302 based GNSS signals received via directional RF antenna 302. For example, if GNSS receiver 306 receives GNSS signals from GNSS satellites 330A, 330B, 330C, and 330D, wireless communication device 301 can conclude that GNSS satellites 330A, 330B, 330C, and 330D are within FOV 320. Given its own position and based on prior knowledge of the geocentric positions of GNSS satellites 330A, 330B, 330C, and 330D, wireless communication device 301 can infer the orientation of directional RF antenna 302 as one that causes FOV 320 to contain the positions of GNSS satellites 330A, 330B, 330C, and 330D.

SBWC radio 314 also uses directional RF antenna 302, and thus SBWC satellites visible to wireless communication device 301 (if any) will reside within a field-of-view located in the direction corresponding to the orientation of directional RF antenna 302. This field-of-view may be the same as FOV 320, or may generally correspond to FOV 320 but differ to some extent due to various factors (such as, for example, differences between GNSS and SBWC satellite signal strengths, signal modulations, altitudes, and so forth). According to aspects of the disclosure, wireless communication device 301 can infer the orientation of directional RF antenna 302 based on received GNSS signals and estimate a field-of-view based on that orientation. Given its own position and based on prior knowledge of the geocentric positions of SBWC satellites (not shown in FIG. 3A), wireless communication device 301 can then determine, based on the estimated field-of-view, whether any SBWC satellites are visible to SBWC radio 314 via use of directional RF antenna 302.

FIG. 3B is a block diagram illustrating an example operating environment 350, according to aspects of the disclosure. In operating environment 350, a wireless communication device 351 includes the same directional RF antenna 302, GNSS receiver 306, and SBWC radio 314 as wireless communication device 301 of FIG. 3A. wireless communication device 351 also includes an additional directional RF antenna 353. In the case of wireless communication device 351, rather than sharing directional RF antenna 302 with GNSS receiver 306 as it does in the case of wireless communication device 301 of FIG. 3A, SBWC radio 314 communicates using directional RF antenna 353.

In operating environment 350, SBWC satellites visible to wireless communication device 351 (if any) will reside within an FOV 372 located in a direction corresponding to the orientation of directional RF antenna 353, such as may be largely defined by the orientation of a main lobe 357 of the directional RF antenna 353. According to aspects of the disclosure, wireless communication device 351 can infer the orientation of directional RF antenna 302 based on received GNSS signals and estimate an orientation of directional RF antenna 353 based on the inferred orientation of directional RF antenna 302 and prior knowledge of the difference between the respective orientations of directional RF antenna 353 and directional RF antenna 302. Wireless communication device 351 can then estimate FOV 372 based on the estimated orientation of directional RF antenna 353, and given its own position and based on its estimate of FOV 372 and prior knowledge of the geocentric positions of SBWC satellites (not shown in FIG. 3B), can determine whether any SBWC satellites are visible to SBWC radio 314 via use of directional RF antenna 353.

According to aspects of the disclosure, perturbances caused by external factors (such as wireless communication device 351 being held in a hand or being located in proximity to a large conductive object) may affect the respective antenna lobes of directional RF antennas 302 and 353 differently. In some cases, the manner in which those effects differ may depend on the nature of the perturbance. According to aspects of the disclosure, a model for estimating FOV 372 can be trained using a machine-learning algorithm designed to account for various types of perturbances and their potentially varying effects in conjunction with inferring the orientation of directional RF antenna 302 and estimating the orientation of directional RF antenna 353. The lobe direction and the FOV (e.g., FOV 372) of different antennas (e.g., directional RF antennas 302 and 353) may be affected in different ways by the same perturbations. In some embodiments, as noted above, one or more machine learning algorithms (e.g., for separately and/or jointly estimating directional RF antennas 302 and 353) may be used to better take into account those differences.

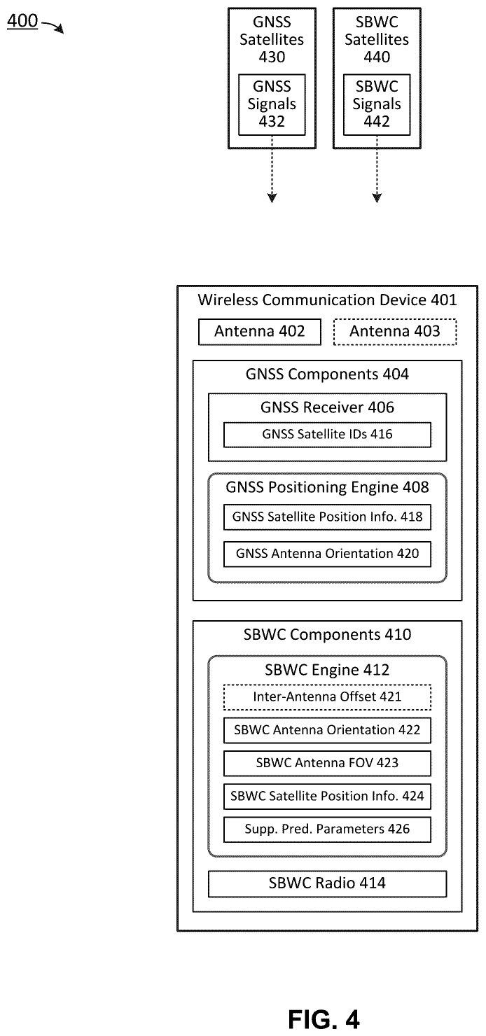

FIG. 4 is a block diagram illustrating an example operating environment 400 that may be representative of the implementation of techniques disclosed herein for SBWC satellite visibility determination based on GNSS satellite visibility, according to aspects of the disclosure. In operating environment 400, a wireless communication device 401 can determine the visibility (or lack thereof) of SBWC satellites 440 based on GNSS signals 432 received from GNSS satellites 430.

As shown in FIG. 4, wireless communication device 401 can include an antenna 402, GNSS components 404, and SBWC components 410. Antenna 402 can be a directional RF antenna. GNSS components 404 can provide wireless communication device 401 with GNSS-based positioning capabilities that allow wireless communication device 401 to conduct positioning based on GNSS signals 432 transmitted by GNSS satellites 430. GNSS components 404 can include a GNSS receiver 406 capable of receiving GNSS signals 432 using antenna 402. GNSS receiver 406 can measure received GNSS signals 432 to obtain GNSS measurements used for GNSS positioning.

GNSS components 404 can execute—for example, using one or more included processors (not shown in FIG. 4)-a GNSS positioning engine 408. GNSS positioning engine 408 can generate GNSS-based positioning estimates based on GNSS measurements provided by GNSS receiver 406. In some implementations, such GNSS-based positioning estimates can include estimated positions and estimated velocities. In some implementations, the estimated positions can be positions of the wireless communication device 401 estimated with respect to three dimensions. In some implementations, the estimated velocities can be scalar (directionless) parameters representing estimated speeds of motion of the wireless communication device 401. In some other implementations, the estimated velocities can be vectors representing estimated speeds of motion of the wireless communication device 401 and estimated directions of such motion. In some such implementations, the estimated directions can be directions of motion of the wireless communication device 401 estimated with respect to three dimensions. In some implementations, GNSS receiver 406 can execute GNSS positioning engine 408. In some implementations, GNSS receiver 406 can generate GNSS measurements and then generate GNSS-based positioning estimates based on the GNSS measurements.

According to aspects of the disclosure, GNSS receiver 406 can process received GNSS signals 432 to determine GNSS satellite identifiers (IDs) 416 associated with the GNSS satellites 430 from which the GNSS signals 432 were received. GNSS positioning engine 408 can then consult GNSS satellite position information 418 to determine geocentric positions of the GNSS satellites 430 corresponding to the GNSS satellite IDs 416 provided by GNSS receiver 406. GNSS satellite position information 418 can comprise information indicating geocentric positions of GNSS satellites 430, such as an orbital schedule. Given a current geocentric position of wireless communication device 401 and the geocentric positions of the GNSS satellites 430 corresponding to the GNSS satellite IDs 416, GNSS positioning engine 408 can infer a GNSS antenna orientation 420 that represents an orientation of antenna 402.

SBWC components 410 can include an SBWC radio 414, and can execute—for example, using one or more included processors (not shown in FIG. 4)—an SBWC engine 412. According to aspects of the disclosure, SBWC engine 412 can determine an SBWC antenna orientation 422 based on GNSS antenna orientation 420, and can determine whether any SBWC satellites 440 are visible based on the SBWC antenna orientation 422. The SBWC antenna orientation 422 can represent an orientation of a directional RF antenna to be used by SBWC radio 414 for communication with SBWC satellites 440 (for example, to receive SBWC signals 442 from SBWC satellites 440).

In some examples, GNSS receiver 406 and SBWC radio 414 can share antenna 402. In such examples, SBWC engine 412 can identify SBWC antenna orientation 422 as the same orientation as the GNSS antenna orientation 420 estimated by GNSS positioning engine 408. In some other examples, wireless communication device 401 can include an additional antenna 403 (which can be a directional RF antenna), and SBWC radio 414 can be configured to use that antenna 403 for communication with SBWC satellites 440. In such examples, SBWC engine 412 can estimate SBWC antenna orientation 422 based on GNSS antenna offset 420 and an inter-antenna offset 421. Inter-antenna offset 421 can represent a offset between the respective orientations of antennas 402 and 403, which-assuming antennas 402 and 403 are substantially fixed within wireless communication device 401—can be expected to remain substantially constant over time. In some examples, inter-antenna offset 421 can be determined during an initial calibration process for wireless communication device 401 and stored in non-volatile memory, from which SBWC engine 412 can retrieve it in conjunction with estimating SBWC antenna orientation 422.

In some examples, in conjunction with determining whether any SBWC satellites 440 are visible based on SBWC antenna orientation 422, SBWC engine 412 can estimate an SBWC antenna FOV 423 based on SBWC antenna orientation 422. SBWC antenna FOV 423 can represent a region of sky with respect to which SBWC signals 442 transmitted by SBWC satellites 440 within that region should be receivable by SBWC radio 414 using the directional RF antenna (antenna 402 or 403) that it is configured to use to communicate with SBWC satellites 440. In some examples, SBWC engine 412 can estimate SBWC antenna FOV 423 based on SBWC antenna orientation 422 and antenna parameters (such as a beamwidth) of the directional RF antenna (antenna 402 or 403) that it is configured to use to communicate with SBWC satellites 440.

In some examples, SBWC engine 412 can consult SBWC satellite position information 424 to determine whether any SBWC satellites 440 are located within SBWC antenna FOV 423. SBWC satellite position information 424 can comprise information indicating geocentric positions of SBWC satellites 440. In some examples, SBWC engine 412 can determine that no SBWC satellites 440 are visible if no SBWC satellites are located within SBWC antenna FOV 423.

In some examples, SBWC engine 412 can determine whether any SBWC satellites 440 are visible based on SBWC antenna orientation 422, SBWC satellite position information 424, and supplemental prediction parameters 426. Supplemental prediction parameters 426 can comprise information relating to other factors that may affect the ability of SBWC radio 414 to successfully receive and process SBWC signals 442 from SBWC satellites 440. Examples of supplemental prediction parameters 426 can include, without limitation, proximity sensor information, accelerometer sensor information, gyroscopic sensor information, magnetometer sensor information, time-of-day information, and temperature sensor information.

According to aspects of the disclosure, if SBWC engine 412 determines that one or more SBWC satellites 440 are visible, it can initiate an SBWC communication procedure. According to the SBWC communication procedure, SBWC radio 414 can monitor a wireless frequency band for SBWC signals 442 transmitted by SBWC satellites 440. If SBWC engine 412 determines that no SBWC satellites 440 are visible, it can refrain from initiating the SBWC communication procedure. According to aspects of the disclosure, by adaptively monitoring (or not monitoring) the wireless frequency band based on the presence (or absence) of visible SBWC satellites 440, wireless communication device 401 can conserve power that may otherwise be wasted in conjunction with monitoring the wireless frequency band during times when there are not likely to be any receivable SBWC signals 442.

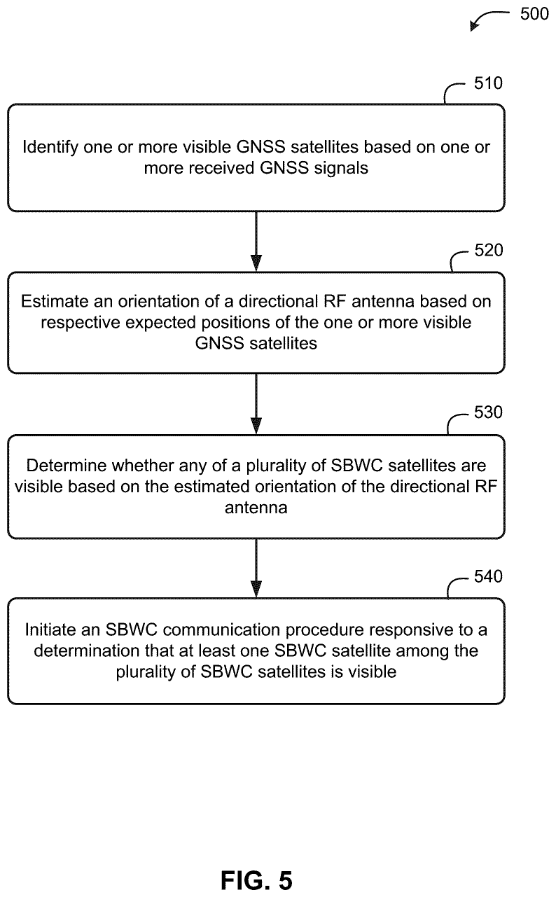

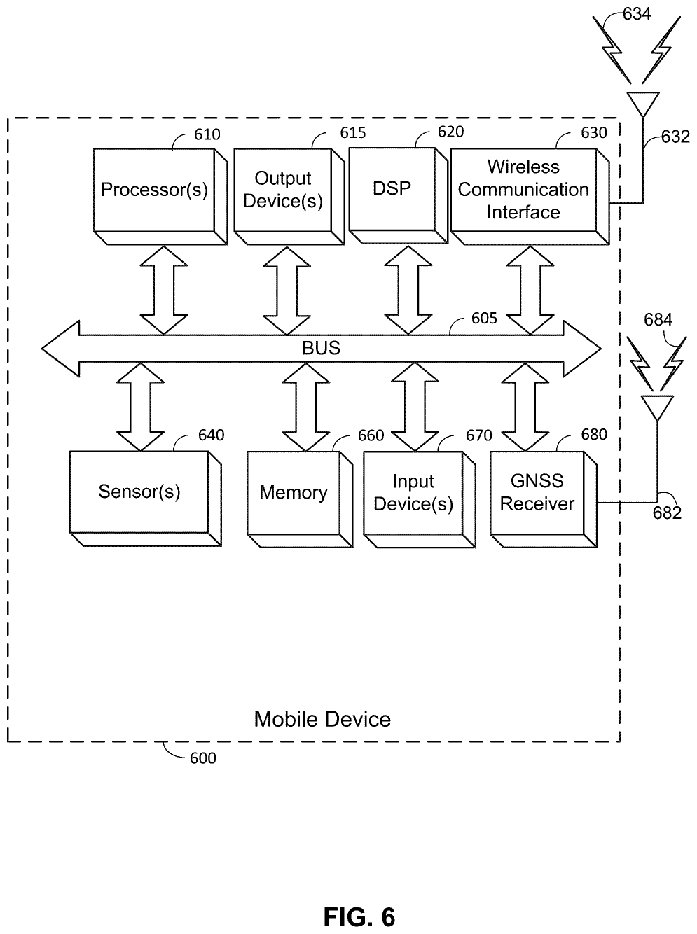

FIG. 5 is a block diagram showing an example satellite visibility determination method 500, according to aspects of the disclosure. In some implementations, means for performing the functionality illustrated in one or more of the blocks shown in FIG. 5 may be provided by hardware and/or software components of a mobile device. Example components of a mobile device are illustrated in FIG. 6, which is described in more detail below. In some examples, wireless communication device 401 may perform the functionality illustrated in one or more of the blocks shown in FIG. 5 in operating environment 400 of FIG. 4.

At block 510, the functionality comprises identifying one or more visible GNSS satellites based on one or more received GNSS signals. For example, in operating environment 400 of FIG. 4, wireless communication device 401 may identify one or more visible GNSS satellites 430 based on GNSS signals 432 received from those GNSS satellites 430. Means for performing functionality at block 510 may comprise a bus 605, processors 610, digital signal processor (DSP) 620, wireless communication interface 630, memory 660, and/or other components of a mobile device, as illustrated in FIG. 6.

At block 520, the functionality comprises estimating an orientation of a directional RF antenna based on respective expected positions of the one or more visible GNSS satellites. For example, in operating environment 400 of FIG. 4, wireless communication device 401 may determine, based on GNSS satellite position information 418, expected positions of visible GNSS satellites 430 identified based on received GNSS signals 432, and may estimate SBWC antenna orientation 422 based on those expected positions. Means for performing functionality at block 510 may comprise a bus 605, processors 610, digital signal processor (DSP) 620, wireless communication interface 630, memory 660, and/or other components of a mobile device, as illustrated in FIG. 6.

In some examples, the directional RF antenna for which the orientation is estimated at block 520 can be a same directional RF antenna as one via which the one or more received GNSS signals of block 510 are received. In other examples, the one or more received GNSS signals of block 510 can be received via a second directional RF antenna. In some such examples, an orientation of the second directional RF antenna can be estimated based on the respective positions of the one or more visible GNSS satellites, and the orientation of the directional RF antenna can be estimated based on the estimated orientation of the second directional RF antenna. In some examples, estimating the orientation of the directional RF antenna based on the estimated orientation of the second directional RF antenna can include translating the estimated orientation of the second directional RF antenna according to an orientation offset indicating a difference between the respective orientations of the directional RF antenna and the second directional RF antenna.

At block 530, the functionality comprises determining whether any of a plurality of SBWC satellites are visible based on the estimated orientation of the directional RF antenna. For example, in operating environment 400 of FIG. 4, wireless communication device 401 may determine whether any SBWC satellites 440 are visible based on SBWC antenna orientation 422. Means for performing functionality at block 510 may comprise a bus 605, processors 610, digital signal processor (DSP) 620, wireless communication interface 630, memory 660, and/or other components of a mobile device, as illustrated in FIG. 6.

In some examples, field-of-view of the directional RF antenna can be estimated based on the estimated orientation of the directional RF antenna, it can be determined whether any of the plurality of SBWC satellites are visible based on whether respective expected positions of any of the plurality of SBWC satellites are within the estimated field-of-view of the directional RF antenna. In some such examples, the field-of-view of the directional RF antenna can be estimated based on the estimated orientation of the directional RF antenna and a beamwidth of the directional RF antenna.

In some examples, it can be determined whether any of the plurality of SBWC satellites are visible based on the estimated orientation of the directional RF antenna, respective expected positions of the plurality of SBWC satellites, and one or more supplemental prediction parameters. In some such examples, the one or more supplemental prediction parameters can include proximity sensor information, accelerometer sensor information, gyroscopic sensor information, magnetometer sensor information, time-of-day information, temperature sensor information, or a combination thereof.

In some examples, a visibility metric for an SBWC satellite among the plurality of SBWC satellites can be determined based on the estimated orientation of the directional RF antenna, an expected position of the SBWC satellite, and the one or more supplemental prediction parameters. In some such examples, the visibility metric for the SBWC satellite can be determined using a machine-learning model, based on the estimated orientation of the directional RF antenna, the expected position of the SBWC satellite, and the one or more supplemental prediction parameters. In some examples, it can be determined whether the SBWC satellite is visible based on a comparison of the visibility metric for the SBWC satellite with a threshold value.

At block 540, the functionality comprises initiating an SBWC communication procedure responsive to a determination that at least one SBWC satellite among the plurality of SBWC satellites is visible. For example, in operating environment 400 of FIG. 4, wireless communication device 401 may initiate an SBWC communication procedure responsive to a determination that at least one SBWC satellite 440 is visible. Means for performing functionality at block 510 may comprise a bus 605, processors 610, digital signal processor (DSP) 620, wireless communication interface 630, memory 660, and/or other components of a mobile device, as illustrated in FIG. 6. In some examples, the SBWC communication procedure can include monitoring a wireless frequency band, by an SBWC radio communicatively coupled with the directional RF antenna, for SBWC signals.

FIG. 6 is a block diagram of an embodiment of a mobile device 600, which can be utilized as described herein above (e.g., in association with FIGS. 1-5). For example, the mobile device 600 can be used to implement one or more of mobile device 105 of FIG. 1, wireless communication device 301 of FIG. 3A, wireless communication device 351 of FIG. 3B, and wireless communication device 401 of FIG. 4. In some examples, mobile device 600 can perform one or more operations associated with satellite visibility determination method 500 of FIG. 5. It should be noted that FIG. 6 is meant only to provide a generalized illustration of various components, any or all of which may be utilized as appropriate. It can be noted that, in some instances, components illustrated by FIG. 6 can be localized to a single physical device and/or distributed among various networked devices, which may be disposed at different physical locations. Furthermore, as previously noted, the functionality of the mobile device discussed in the previously described embodiments may be executed by one or more of the hardware and/or software components illustrated in FIG. 6.

The mobile device 600 is shown comprising hardware elements that can be electrically coupled via a bus 605 (or may otherwise be in communication, as appropriate). The hardware elements may include a processor(s) 610 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 610 may comprise one or more processing units, which may be housed in a single integrated circuit (IC) or multiple ICs. As shown in FIG. 6, some embodiments may have a separate DSP 620, depending on desired functionality. Location determination and/or other determinations based on wireless communication may be provided in the processor(s) 610 and/or wireless communication interface 630 (discussed below). The mobile device 600 also can include one or more input devices 670, which can include without limitation one or more keyboards, touch screens, touch pads, microphones, buttons, dials, switches, and/or the like; and one or more output devices 615, which can include without limitation one or more displays (e.g., touch screens), light emitting diodes (LEDs), speakers, and/or the like.

The mobile device 600 may also include a wireless communication interface 630, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the mobile device 600 to communicate with other devices as described in the embodiments above. The wireless communication interface 630 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 632 that send and/or receive wireless signals 634. According to some embodiments, the wireless communication antenna(s) 632 may comprise a plurality of discrete antennas, antenna arrays, or any combination thereof. The antenna(s) 632 may be capable of transmitting and receiving wireless signals using beams (e.g., Tx beams and Rx beams). Beam formation may be performed using digital and/or analog beam formation techniques, with respective digital and/or analog circuitry. The wireless communication interface 630 may include such circuitry.

Depending on desired functionality, the wireless communication interface 630 may comprise a separate receiver and transmitter, or any combination of transceivers, transmitters, and/or receivers to communicate with base stations (e.g., ng-eNBs and gNBs) and other terrestrial transceivers, such as wireless devices and access points. The mobile device 600 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The mobile device 600 can further include sensor(s) 640. Sensor(s) 640 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the mobile device 600 may also include a Global Navigation Satellite System (GNSS) receiver 680 capable of receiving signals 684 from one or more GNSS satellites using an antenna 682 (which could be the same as antenna 632). Positioning based on GNSS signal measurement can be utilized to complement and/or incorporate the techniques described herein. The GNSS receiver 680 can extract a position of the mobile device 600, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 680 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 680 is illustrated in FIG. 6 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 610, DSP 620, and/or a processor within the wireless communication interface 630 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 610 or DSP 620.

The mobile device 600 may further include and/or be in communication with a memory 660. The memory 660 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 660 of the mobile device 600 also can comprise software elements (not shown in FIG. 6), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 660 that are executable by the mobile device 600 (and/or processor(s) 610 or DSP 620 within mobile device 600). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method for wireless communication by a wireless communication device, including identifying one or more visible global navigation satellite system (GNSS) satellites based on one or more received GNSS signals, estimating an orientation of a directional radio-frequency (RF) antenna based on respective expected positions of the one or more visible GNSS satellites, determining whether any of a plurality of satellite-based wireless communication (SBWC) satellites are visible based on the estimated orientation of the directional RF antenna, and initiating an SBWC communication procedure responsive to a determination that at least one SBWC satellite among the plurality of SBWC satellites is visible.
Clause 2. The method of clause 1, where determining whether any of the plurality of SBWC satellites are visible includes estimating a field-of-view of the directional RF antenna based on the estimated orientation of the directional RF antenna, and determining whether any of the plurality of SBWC satellites are visible based on whether respective expected positions of any of the plurality of SBWC satellites are within the estimated field-of-view of the directional RF antenna.
Clause 3. The method of clause 2, where estimating the field-of-view of the directional RF antenna includes estimating the field-of-view of the directional RF antenna based on the estimated orientation of the directional RF antenna and a beamwidth of the directional RF antenna.
Clause 4. The method of any of clauses 1 to 3, where determining whether any of the plurality of SBWC satellites are visible is based on the estimated orientation of the directional RF antenna, respective expected positions of the plurality of SBWC satellites, and one or more supplemental prediction parameters.
Clause 5. The method of clause 4, where the one or more supplemental prediction parameters include proximity sensor information, accelerometer sensor information, gyroscopic sensor information, magnetometer sensor information, time-of-day information, temperature sensor information, or a combination thereof.
Clause 6. The method of any of clauses 4 to 5, further including determining a visibility metric for an SBWC satellite among the plurality of SBWC satellites based on the estimated orientation of the directional RF antenna, an expected position of the SBWC satellite, and the one or more supplemental prediction parameters.
Clause 7. The method of clause 6, further including determining the visibility metric for the SBWC satellite using a machine-learning model, based on the estimated orientation of the directional RF antenna, the expected position of the SBWC satellite, and the one or more supplemental prediction parameters.
Clause 8. The method of any of clauses 6 to 7, further including determining whether the SBWC satellite is visible based on a comparison of the visibility metric for the SBWC satellite with a threshold value.
Clause 9. The method of any of clauses 1 to 8, further including receiving the one or more received GNSS signals via the directional RF antenna.
Clause 10. The method of any of clauses 1 to 9, further including receiving the one or more received GNSS signals via a second directional RF antenna.
Clause 11. The method of clause 10, further including estimating an orientation of the second directional RF antenna based on the respective expected positions of the one or more visible GNSS satellites, and estimating the orientation of the directional RF antenna based on the estimated orientation of the second directional RF antenna.
Clause 12. The method of clause 11, where estimating the orientation of the directional RF antenna based on the estimated orientation of the second directional RF antenna includes translating the estimated orientation of the second directional RF antenna according to an orientation offset indicating a difference between the respective orientations of the directional RF antenna and the second directional RF antenna.
Clause 13. The method of any of clauses 1 to 12, further comprising: estimating the orientation of the directional radio-frequency (RF) antenna and an orientation of the second directional RF antenna using one or more machine-learning models.
Clause 14. The method of any of clauses 1 to 13, where the SBWC communication procedure includes monitoring a wireless frequency band, by an SBWC radio communicatively coupled with the directional RF antenna, for SBWC signals.
Clause 15. A wireless communication device, including at least one directional radio frequency (RF) antenna, a satellite-based wireless communication (SBWC) radio communicatively coupled with the at least one directional RF antenna, a global navigation satellite system (GNSS) receiver configured to receive one or more GNSS signals, a memory, and one or more processors communicatively coupled with the SBWC radio, the GNSS receiver, and the memory, where the one or more processors are configured to identify one or more visible GNSS satellites based on the one or more received GNSS signals, estimate an orientation of the at least one directional RF antenna based on respective expected positions of the one or more visible GNSS satellites, determine whether any of a plurality of SBWC satellites are visible based on the estimated orientation of the at least one directional RF antenna, and initiate an SBWC communication procedure responsive to a determination that at least one SBWC satellite among the plurality of SBWC satellites is visible.
Clause 16. The wireless communication device of clause 15, where, to determine whether any of the plurality of SBWC satellites are visible, the one or more processors are configured to estimate a field-of-view of the at least one directional RF antenna based on the estimated orientation of the at least one directional RF antenna, and determine whether any of the plurality of SBWC satellites are visible based on whether respective expected positions of any of the plurality of SBWC satellites are within the estimated field-of-view of the at least one directional RF antenna.
Clause 17. The wireless communication device of clause 16, where, to estimate the field-of-view of the at least one directional RF antenna, the one or more processors are configured to estimate the field-of-view of the at least one directional RF antenna based on the estimated orientation of the directional RF antenna and a beamwidth of the at least one directional RF antenna.
Clause 18. The wireless communication device of any of clauses 15 to 17, where the one or more processors are configured to determine whether any of the plurality of SBWC satellites are visible based on the estimated orientation of the at least one directional RF antenna, respective expected positions of the plurality of SBWC satellites, and one or more supplemental prediction parameters.
Clause 19. The wireless communication device of clause 18, where the one or more supplemental prediction parameters include proximity sensor information, accelerometer sensor information, gyroscopic sensor information, magnetometer sensor information, time-of-day information, temperature sensor information, or a combination thereof.
Clause 20. The wireless communication device of any of clauses 18 to 19, where the one or more processors are configured to determine a visibility metric for an SBWC satellite among the plurality of SBWC satellites based on the estimated orientation of the at least one directional RF antenna, an expected position of the SBWC satellite, and the one or more supplemental prediction parameters.
Clause 21. The wireless communication device of clause 20, where the one or more processors are configured to determine the visibility metric for the SBWC satellite using a machine-learning model, based on the estimated orientation of the at least one directional RF antenna, the expected position of the SBWC satellite, and the one or more supplemental prediction parameters.
Clause 22. The wireless communication device of any of clauses 20 to 21, where the one or more processors are configured to determine whether the SBWC satellite is visible based on a comparison of the visibility metric for the SBWC satellite with a threshold value.
Clause 23. The wireless communication device of any of clauses 15 to 22, where the GNSS receiver is configured to receive the one or more received GNSS signals via the at least one directional RF antenna.
Clause 24. The wireless communication device of any of clauses 15 to 23, further including a second directional RF antenna, where the GNSS receiver is configured to receive the one or more received GNSS signals via the second directional RF antenna.
Clause 25. The wireless communication device of clause 24, where the one or more processors are configured to estimate an orientation of the second directional RF antenna based on the respective expected positions of the one or more visible GNSS satellites, and estimate the orientation of the at least one directional RF antenna based on the estimated orientation of the second directional RF antenna.
Clause 26. The wireless communication device of clause 25, where to estimate the orientation of the at least one directional RF antenna based on the estimated orientation of the second directional RF antenna, the one or more processors are configured to translate the estimated orientation of the second directional RF antenna according to an orientation offset indicating a difference between the respective orientations of the at least one directional RF antenna and the second directional RF antenna.
Clause 27. The wireless communication device of any of clauses 15 to 26, further comprising a second directional RF antenna configured to receive the one or more received GNSS signals, wherein, the one or more processors are further configured to: estimate the orientation of the at least one RF antenna and an orientation of the second directional RF antenna using one or more machine-learning models.
Clause 28. The wireless communication device of any of clauses 15 to 26, where the SBWC communication procedure includes monitoring a wireless frequency band, by the SBWC radio using the at least one directional RF antenna, for SBWC signals.
Clause 29. A wireless communication apparatus, including means for identifying one or more visible global navigation satellite system (GNSS) satellites based on one or more received GNSS signals, means for estimating an orientation of a directional radio-frequency (RF) antenna based on respective expected positions of the one or more visible GNSS satellites, means for determining whether any of a plurality of satellite-based wireless communication (SBWC) satellites are visible based on the estimated orientation of the directional RF antenna, and means for initiating an SBWC communication procedure responsive to a determination that at least one SBWC satellite among the plurality of SBWC satellites is visible.
Clause 30. The wireless communication apparatus of clause 29, where the means for determining whether any of a plurality of SBWC satellites are visible based on the estimated orientation of the directional RF antenna include means for estimating a field-of-view of the directional RF antenna based on the estimated orientation of the directional RF antenna, and means for determining whether any of the plurality of SBWC satellites are visible based on whether respective expected positions of any of the plurality of SBWC satellites are within the estimated field-of-view of the directional RF antenna.
Clause 31. The wireless communication apparatus of clause 30, where the means for estimating the field-of-view of the directional RF antenna based on the estimated orientation of the directional RF antenna include means for estimating the field-of-view of the directional RF antenna based on the estimated orientation of the directional RF antenna and a beamwidth of the directional RF antenna.
Clause 32. The wireless communication apparatus of any of clauses 29 to 31, further including means for determining whether any of the plurality of SBWC satellites are visible based on the estimated orientation of the directional RF antenna, respective expected positions of the plurality of SBWC satellites, and one or more supplemental prediction parameters.
Clause 33. The wireless communication apparatus of clause 32, where the one or more supplemental prediction parameters include proximity sensor information, accelerometer sensor information, gyroscopic sensor information, magnetometer sensor information, time-of-day information, temperature sensor information, or a combination thereof.
Clause 34. The wireless communication apparatus of any of clauses 32 to 33, further including means for determining a visibility metric for an SBWC satellite among the plurality of SBWC satellites based on the estimated orientation of the directional RF antenna, an expected position of the SBWC satellite, and the one or more supplemental prediction parameters.
Clause 35. The wireless communication apparatus of clause 34, further including means for determining the visibility metric for the SBWC satellite using a machine-learning model, based on the estimated orientation of the directional RF antenna, the expected position of the SBWC satellite, and the one or more supplemental prediction parameters.
Clause 36. The wireless communication apparatus of any of clauses 34 to 35, further including means for determining whether the SBWC satellite is visible based on a comparison of the visibility metric for the SBWC satellite with a threshold value.
Clause 37. The wireless communication apparatus of any of clauses 29 to 36, further including means for receiving the one or more received GNSS signals via the directional RF antenna.
Clause 38. The wireless communication apparatus of any of clauses 29 to 37, further including means for receiving the one or more received GNSS signals via a second directional RF antenna.
Clause 39. The wireless communication apparatus of clause 38, further including means for estimating an orientation of the second directional RF antenna based on the respective expected positions of the one or more visible GNSS satellites, and means for estimating the orientation of the directional RF antenna based on the estimated orientation of the second directional RF antenna.
Clause 40. The wireless communication apparatus of clause 39, where estimating the orientation of the directional RF antenna based on the estimated orientation of the second directional RF antenna includes translating the estimated orientation of the second directional RF antenna according to an orientation offset indicating a difference between the respective orientations of the directional RF antenna and the second directional RF antenna.
Clause 41. The wireless communication apparatus of any of clauses 29 to 40, further comprising means for estimating the orientation of the directional radio-frequency (RF) antenna and an orientation of the second directional RF antenna using one or more machine-learning models.
Clause 42. The wireless communication apparatus of any of clauses 29 to 40, where the SBWC communication procedure includes monitoring a wireless frequency band, by an SBWC radio communicatively coupled with the directional RF antenna, for SBWC signals.
Clause 43. A non-transitory computer-readable medium storing instructions for wireless communication by a wireless communication device, the instructions including code to identify one or more visible global navigation satellite system (GNSS) satellites based on one or more received GNSS signals, estimate an orientation of a directional radio-frequency (RF) antenna based on respective expected positions of the one or more visible GNSS satellites, determine whether any of a plurality of satellite-based wireless communication (SBWC) satellites are visible based on the estimated orientation of the directional RF antenna, and initiate an SBWC communication procedure responsive to a determination that at least one SBWC satellite among the plurality of SBWC satellites is visible.
Clause 44. The non-transitory computer-readable medium of clause 43, the instructions further including code to estimate a field-of-view of the directional RF antenna based on the estimated orientation of the directional RF antenna, and determine whether any of the plurality of SBWC satellites are visible based on whether respective expected positions of any of the plurality of SBWC satellites are within the estimated field-of-view of the directional RF antenna.
Clause 45. The non-transitory computer-readable medium of clause 44, the instructions further including code to estimate the field-of-view of the directional RF antenna based on the estimated orientation of the directional RF antenna and a beamwidth of the directional RF antenna.
Clause 46. The non-transitory computer-readable medium of any of clauses 43 to 45, the instructions further including code to determine whether any of the plurality of SBWC satellites are visible based on the estimated orientation of the directional RF antenna, respective expected positions of the plurality of SBWC satellites, and one or more supplemental prediction parameters.
Clause 47. The non-transitory computer-readable medium of clause 46, where the one or more supplemental prediction parameters include proximity sensor information, accelerometer sensor information, gyroscopic sensor information, magnetometer sensor information, time-of-day information, temperature sensor information, or a combination thereof.
Clause 48. The non-transitory computer-readable medium of any of clauses 46 to 47, the instructions further including code to determine a visibility metric for an SBWC satellite among the plurality of SBWC satellites based on the estimated orientation of the directional RF antenna, an expected position of the SBWC satellite, and the one or more supplemental prediction parameters.
Clause 49. The non-transitory computer-readable medium of clause 48, the instructions further including code to determine the visibility metric for the SBWC satellite using a machine-learning model, based on the estimated orientation of the directional RF antenna, the expected position of the SBWC satellite, and the one or more supplemental prediction parameters.
Clause 50. The non-transitory computer-readable medium of any of clauses 48 to 49, the instructions further including code to determine whether the SBWC satellite is visible based on a comparison of the visibility metric for the SBWC satellite with a threshold value.
Clause 51. The non-transitory computer-readable medium of any of clauses 43 to 50, the instructions further including code to receive the one or more received GNSS signals via the directional RF antenna.
Clause 52. The non-transitory computer-readable medium of any of clauses 43 to 51, the instructions further including code to receive the one or more received GNSS signals via a second directional RF antenna.
Clause 53. The non-transitory computer-readable medium of clause 52, the instructions further including code to estimate an orientation of the second directional RF antenna based on the respective expected positions of the one or more visible GNSS satellites, and estimate the orientation of the directional RF antenna based on the estimated orientation of the second directional RF antenna.
Clause 54. The non-transitory computer-readable medium of clause 53, where estimating the orientation of the directional RF antenna based on the estimated orientation of the second directional RF antenna includes translating the estimated orientation of the second directional RF antenna according to an orientation offset indicating a difference between the respective orientations of the directional RF antenna and the second directional RF antenna.
Clause 55. The non-transitory computer-readable medium of any of clauses 40 to 54, where the instructions further including code to estimating the orientation of the directional radio-frequency (RF) antenna and an orientation of the second directional RF antenna using one or more machine-learning models.
Clause 56. The non-transitory computer-readable medium of any of clauses 40 to 54, where the SBWC communication procedure includes monitoring a wireless frequency band, by an SBWC radio communicatively coupled with the directional RF antenna, for SBWC signals.

What is claimed is:

1. A method for wireless communication by a wireless communication device, comprising:
identifying one or more visible global navigation satellite system (GNSS) satellites based on one or more received GNSS signals;
estimating an orientation of a directional radio-frequency (RF) antenna based on respective expected positions of the one or more visible GNSS satellites;
determining whether any of a plurality of satellite-based wireless communication (SBWC) satellites are visible based on the estimated orientation of the directional RF antenna; and
initiating an SBWC communication procedure responsive to a determination that at least one SBWC satellite among the plurality of SBWC satellites is visible.

2. The method of claim 1, wherein determining whether any of the plurality of SBWC satellites are visible comprises:
estimating a field-of-view of the directional RF antenna based on the estimated orientation of the directional RF antenna; and
determining whether any of the plurality of SBWC satellites are visible based on whether respective expected positions of any of the plurality of SBWC satellites are within the estimated field-of-view of the directional RF antenna.

3. The method of claim 2, wherein estimating the field-of-view of the directional RF antenna comprises estimating the field-of-view of the directional RF antenna based on the estimated orientation of the directional RF antenna and a beamwidth of the directional RF antenna.

4. The method of claim 1, wherein determining whether any of the plurality of SBWC satellites are visible is based on:
the estimated orientation of the directional RF antenna;
respective expected positions of the plurality of SBWC satellites; and
one or more supplemental prediction parameters.

5. The method of claim 4, wherein the one or more supplemental prediction parameters include:
proximity sensor information;
accelerometer sensor information;
gyroscopic sensor information;
magnetometer sensor information;
time-of-day information;
temperature sensor information; or
a combination thereof.

6. The method of claim 4, further comprising determining a visibility metric for an SBWC satellite among the plurality of SBWC satellites based on the estimated orientation of the directional RF antenna, an expected position of the SBWC satellite, and the one or more supplemental prediction parameters.

7. The method of claim 6, further comprising determining the visibility metric for the SBWC satellite using a machine-learning model, based on the estimated orientation of the directional RF antenna, the expected position of the SBWC satellite, and the one or more supplemental prediction parameters.

8. The method of claim 6, further comprising determining whether the SBWC satellite is visible based on a comparison of the visibility metric for the SBWC satellite with a threshold value.

9. The method of claim 1, further comprising receiving the one or more received GNSS signals via the directional RF antenna.

10. The method of claim 1, further comprising receiving the one or more received GNSS signals via a second directional RF antenna.

11. The method of claim 10, further comprising:
estimating an orientation of the second directional RF antenna based on the respective expected positions of the one or more visible GNSS satellites; and
estimating the orientation of the directional RF antenna based on the estimated orientation of the second directional RF antenna.

12. The method of claim 11, wherein estimating the orientation of the directional RF antenna based on the estimated orientation of the second directional RF antenna includes translating the estimated orientation of the second directional RF antenna according to an orientation offset indicating a difference between the respective orientations of the directional RF antenna and the second directional RF antenna.

13. The method of claim 10, further comprising:
estimating the orientation of the directional RF antenna and an orientation of the second directional RF antenna using one or more machine-learning models.

14. The method of claim 1, wherein the SBWC communication procedure includes monitoring a wireless frequency band, by an SBWC radio communicatively coupled with the directional RF antenna, for SBWC signals.

15. A wireless communication device, comprising:
at least one directional radio frequency (RF) antenna;
a satellite-based wireless communication (SBWC) radio communicatively coupled with the at least one directional RF antenna;
a global navigation satellite system (GNSS) receiver configured to receive one or more GNSS signals;
a memory; and
one or more processors communicatively coupled with the SBWC radio, the GNSS receiver, and the memory, wherein the one or more processors are configured to:
identify one or more visible GNSS satellites based on the one or more received GNSS signals;
estimate an orientation of the at least one directional RF antenna based on respective expected positions of the one or more visible GNSS satellites;
determine whether any of a plurality of SBWC satellites are visible based on the estimated orientation of the at least one directional RF antenna; and
initiate an SBWC communication procedure responsive to a determination that at least one SBWC satellite among the plurality of SBWC satellites is visible.

16. The wireless communication device of claim 15, wherein, to determine whether any of the plurality of SBWC satellites are visible, the one or more processors are configured to:
estimate a field-of-view of the at least one directional RF antenna based on the estimated orientation of the at least one directional RF antenna; and
determine whether any of the plurality of SBWC satellites are visible based on whether respective expected positions of any of the plurality of SBWC satellites are within the estimated field-of-view of the at least one directional RF antenna.

17. The wireless communication device of claim 16, wherein, to estimate the field-of-view of the at least one directional RF antenna, the one or more processors are configured to estimate the field-of-view of the at least one directional RF antenna based on the estimated orientation of the at least one directional RF antenna and a beamwidth of the at least one directional RF antenna.

18. The wireless communication device of claim 15, wherein the one or more processors are configured to determine whether any of the plurality of SBWC satellites are visible based on:
the estimated orientation of the at least one directional RF antenna;
respective expected positions of the plurality of SBWC satellites; and
one or more supplemental prediction parameters.

19. The wireless communication device of claim 18, wherein the one or more supplemental prediction parameters include:
proximity sensor information;
accelerometer sensor information;
gyroscopic sensor information;
magnetometer sensor information;
time-of-day information;
temperature sensor information; or
a combination thereof.

20. The wireless communication device of claim 18, wherein the one or more processors are configured to determine a visibility metric for an SBWC satellite among the plurality of SBWC satellites based on the estimated orientation of the at least one directional RF antenna, an expected position of the SBWC satellite, and the one or more supplemental prediction parameters.

21. The wireless communication device of claim 20, wherein the one or more processors are configured to determine the visibility metric for the SBWC satellite using a machine-learning model, based on the estimated orientation of the at least one directional RF antenna, the expected position of the SBWC satellite, and the one or more supplemental prediction parameters.

22. The wireless communication device of claim 20, wherein the one or more processors are configured to determine whether the SBWC satellite is visible based on a comparison of the visibility metric for the SBWC satellite with a threshold value.

23. The wireless communication device of claim 15, wherein the one or more processors are configured to receive the one or more received GNSS signals via the at least one directional RF antenna.

24. The wireless communication device of claim 15, wherein the one or more processors are configured to receive the one or more received GNSS signals via a second directional RF antenna.

25. The wireless communication device of claim 24, wherein the one or more processors are configured to:
estimate an orientation of the second directional RF antenna based on the respective expected positions of the one or more visible GNSS satellites; and
estimate the orientation of the at least one directional RF antenna based on the estimated orientation of the second directional RF antenna.

26. The wireless communication device of claim 25, wherein to estimate the orientation of the at least one directional RF antenna based on the estimated orientation of the second directional RF antenna wherein the one or more processors are configured to translate the estimated orientation of the second directional RF antenna according to an orientation offset indicating a difference between the respective orientations of the at least one directional RF antenna and the second directional RF antenna.

27. The wireless communication device of claim 25, further comprising a second directional RF antenna configured to receive the one or more received GNSS signals, wherein, the one or more processors are further configured to:
estimate the orientation of the directional radio-frequency (RF) antenna and an orientation of the second directional RF antenna using one or more machine-learning models.

28. The wireless communication device of claim 15, wherein the SBWC communication procedure includes monitoring a wireless frequency band, by an SBWC radio communicatively coupled with the at least one directional RF antenna, for SBWC signals.

29. A non-transitory computer-readable medium storing instructions for wireless communication by a wireless communication device, the instructions including code to:
identify one or more visible global navigation satellite system (GNSS) satellites based on one or more received GNSS signals;
estimate an orientation of a directional radio-frequency (RF) antenna based on respective expected positions of the one or more visible GNSS satellites;
determine whether any of a plurality of satellite-based wireless communication (SBWC) satellites are visible based on the estimated orientation of the directional RF antenna; and
initiate an SBWC communication procedure responsive to a determination that at least one SBWC satellite among the plurality of SBWC satellites is visible.

30. A wireless communication apparatus, comprising:
means for identifying one or more visible global navigation satellite system (GNSS) satellites based on one or more received GNSS signals;
means for estimating an orientation of a directional radio-frequency (RF) antenna based on respective expected positions of the one or more visible GNSS satellites;
means for determining whether any of a plurality of satellite-based wireless communication (SBWC) satellites are visible based on the estimated orientation of the directional RF antenna; and
means for initiating an SBWC communication procedure responsive to a determination that at least one SBWC satellite among the plurality of SBWC satellites is visible.
